(19) United States
(12) Patent Application Publication
(10) Pub. No.: US 2008/0244157 A1
(43) Pub. Date: Oct. 2, 2008

(54) Semiconductor memory device

(75) Inventor: Dong-Kyun Kim, Kyoungki-do (KR)

Correspondence Address: MCDERMOTT WILL & EMERY LLP, 600 13TH STREET, N.W., WASHINGTON, DC, 20005-3096, US

(73) Assignee: HYNIX SEMICONDUCTOR INC.

(21) Appl. No.: 12/000,028

(22) Filed: Dec. 7, 2007

(30) Foreign Application Priority Data
Mar. 30, 2007 (KR) 10-2007-0031971

(51) Int. Cl. G06F 12/00

(52) U.S. Cl. 711/100; 711/E12.001

(57) ABSTRACT

A semiconductor memory device includes: a memory core region; a data transfer unit configured to transfer external data to the memory core region; a data code storage unit configured to store test data; and a data selection unit configured to select one of the test data from the data code storage unit and the data from the data transfer unit and output the selected data to the memory core region.

### CROSS-REFERENCE TO RELATED APPLICATIONS

The present invention claims priority of Korean patent application number 10-2007-0031971, filed on Mar. 30, 2007, which is incorporated by reference in its entirety.

### BACKGROUND OF THE INVENTION

The present invention relates to a semiconductor memory device, and more particularly, to a semiconductor memory device with a test code read only memory (ROM).

In a multi-functional system with a plurality of semiconductor devices, a semiconductor memory device serves as a data storage. The semiconductor memory device outputs data corresponding to an address received from a data processor, e.g., a central processing unit (CPU), to another device requesting the data, or stores data transferred from the data processor in a cell corresponding to an address received together with the data.

Main operations of the semiconductor memory device include an active operation, a write operation, and a read operation. In the active operation, the semiconductor memory device receives a row address and becomes an active state. Specifically, in the active operation, the semiconductor memory device activates a word line corresponding to the row address, and amplifies data signals from cells corresponding to the activated word line. In the write operation, the semiconductor memory device stores data received together with a column address in cells corresponding to the column address in response to a write command. In the read operation, the semiconductor memory device outputs data stored in cells corresponding to an external column address in response to a read command.

The active command, the write command, and the read command are not inputted directly to the semiconductor memory device. Instead, the semiconductor memory device includes a plurality of command input pads, and detects the active command, the write command, or the read command by using a combination of signals inputted through the command input pads. Generally, the semiconductor memory device includes the command input pads for /CAS, /RAS, /WE, /CS, CKE, CK, and /CK signals.

Meanwhile, the semiconductor memory device is tested after its fabrication is completed. Generally, the test is performed to verify if data are correctly written to or read from memory cells. Particularly, in testing the write operation, a write command, a write address, and a write data are inputted to the semiconductor memory device to be tested. That is, a test apparatus must have many probes for input of the write command, the write address, and the write data in testing one semiconductor memory device. The semiconductor memory device, however, can have the limited number of probes. Hence, the number of semiconductor memory devices capable of being tested at a time is limited.

### SUMMARY OF THE INVENTION

Embodiments of the present invention are directed to providing a semiconductor memory device that can minimize the number of external input signals in a test mode.

Embodiments of the present invention are also directed to providing a semiconductor memory device that can generate a write data and a write address from an internal circuit in a test mode.

Embodiments of the present invention are also directed to providing a semiconductor memory device with a test code ROM.

Embodiments of the present invention are also directed to providing a semiconductor memory device with a circuit block configured to generate a test address.

In accordance with a first aspect of the present invention, there is provided a semiconductor memory device, including: a memory core region; a data transfer unit configured to transfer external data to the memory core region; a data code storage unit configured to store test data; and a data selection unit configured to select one of the test data from the data code storage unit and the data from the data transfer unit and output the selected data to the memory core region.

In accordance with a second aspect of the present invention, there is provided a semiconductor memory device, including: a memory core region; an address transfer unit configured to transfer an external address to the memory core region; a test address generation unit configured to generate a test address; and an address selection unit configured to select one of the test address from the test address generation unit and the address from the address transfer unit and output the selected address to the memory core region.

In accordance with a third aspect of the present invention, there is provided a semiconductor memory device, including: a memory core region; a data transfer unit configured to transfer external data to the memory core region; a data code storage unit configured to store test data; a data selection unit configured to select one of the test data from the data code storage unit and the data from the data transfer unit and output the selected data to the memory core region; an address transfer unit configured to transfer an external address to the memory core region; a test address generation unit configured to generate a test address; and an address selection unit configured to select one of the test address from the test address generation unit and the address from the address transfer unit and output the selected address to the memory core region.

In accordance with a fourth aspect of the present invention, there is provided a semiconductor memory device, including: a data transfer unit configured to transfer external data to a memory core region; a data pattern read only memory (ROM) configured to store test data; a data selection unit configured to select one of the test data from the data pattern ROM and the data from the data transfer unit and output the selected data to the memory core region; a command decoder configured to receive a test enable signal and a test control signal from an external circuit and generate a control signal for controlling the data pattern ROM; and an address counter configured to generate a test address corresponding to the test data stored in the data pattern ROM.

### BRIEF DESCRIPTION OF THE DRAWINGS

FIG. 1 is a block diagram of a semiconductor memory device;

FIG. 2 is a block diagram of a semiconductor memory device in accordance with an embodiment of the present invention;

FIG. 3 is a detailed block diagram of an address counter unit and a data code ROM illustrated in FIG. 2;

FIG. 4 is a table illustrating operation modes of the semiconductor memory device illustrated in FIG. 1; and

FIG. 5 is a table illustrating operation modes of the semiconductor memory device illustrated in FIG. 2.

### DESCRIPTION OF SPECIFIC EMBODIMENTS

Hereinafter, a semiconductor memory device with a test code ROM in accordance with the present invention will be described in detail with reference to the accompanying drawings.

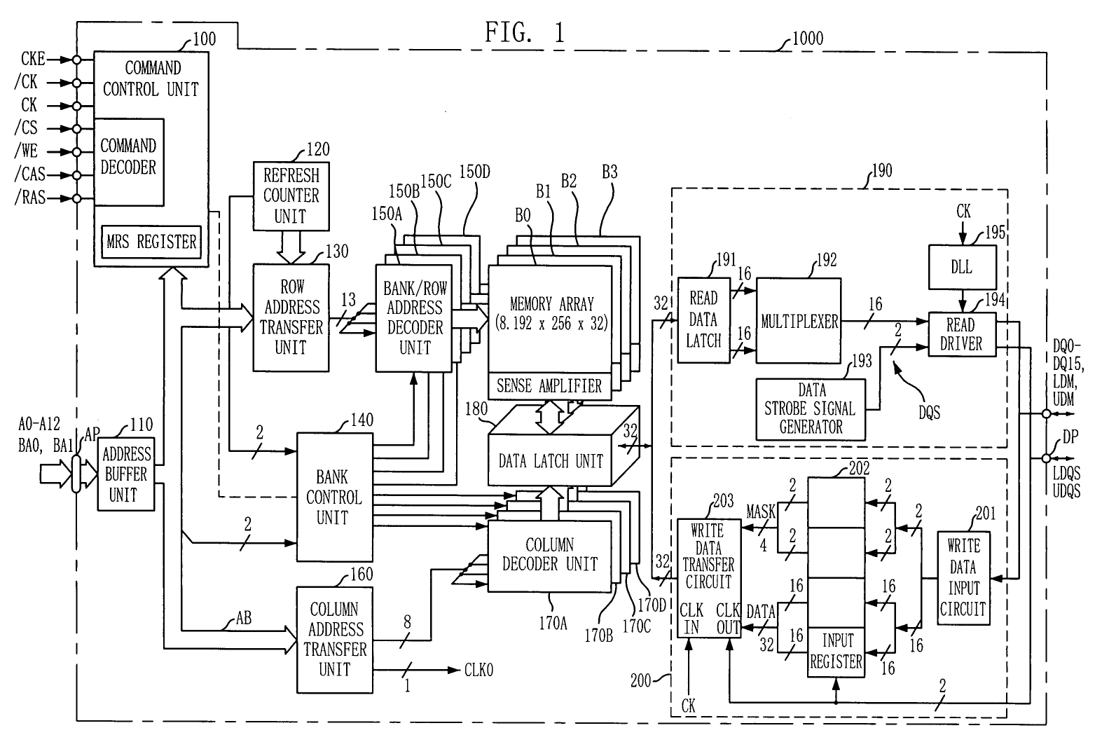

FIG. 1 is a block diagram of a semiconductor memory device.

Referring to FIG. 1, the semiconductor memory device 1000 includes a command control unit 100, an address buffer unit 110, a refresh counter unit 120, a row address transfer unit 130, a bank control unit 140, first to fourth bank/row address decoder units 150A to 150D, first to fourth memory arrays B0 to B3, a column address transfer unit 160, first to fourth column decoder units 170A to 170D, a data latch unit 180, a read data transfer unit 190, and a write data input unit 200. For reference, the first to fourth memory arrays B0 to B3 may form one bank.

The command control unit 100 includes a command decoder and a mode register set (MRS) register. The command decoder decodes external command signals /CAS, /RAS, /WE, /CS, CKE, CK, and /CK, to generate command signals and transfers the generated command signals to corresponding internal blocks. The MRS register stores information about operation modes of the semiconductor memory device.

The address buffer unit 110 receives external bank addresses BA0 and BA1 and addresses A0 to A12 and transfers them to the internal blocks. The addresses A0 to A12 may be a row address or a column address. In order to reduce the number of address input pads, the semiconductor memory device is designed to receive row addresses and column addresses through a command address input pad.

The refresh counter unit 120 counts the row address whenever the semiconductor memory device performs a refresh operation. The row address transfer unit 130 latches the row address received from the address buffer unit 110. The bank control unit 140 latches a bank address received from the address buffer unit 110. The bank/row address decoders 150A to 150D decode the row address from the row address transfer unit 130 and the bank address from the bank control unit 140 to select one of the memory arrays B0 to B3 and activate word lines of the selected memory array. The data latch unit 180 latches data of cells corresponding to the activated word lines. Each of the memory arrays B0 to B3 has a plurality of word lines, a plurality of bit lines, and unit cells disposed at intersections between the word lines and the bit lines.

The column address transfer unit 160 latches the column address received from the address buffer unit 110 and transfers the latched column address to the column decoder units 170A to 170D. The column decoder units 170A to 170D decode the column address from the column address transfer unit 160 and transfer the decoded column address to the data latch unit 180. Upon execution of a read command, the data latch unit 180 transfers data corresponding to the decoded column address to the read data transfer unit 190. Upon execution of a write command, the data latch unit 180 replaces the latched data with data received from the write data input unit 200. The replaced data are stored in a predetermined cell of the memory array.

The read data transfer unit 190 includes a read data latch 191, a multiplexer 192, a data strobe signal generator 193, a read driver 194, and a delay locked loop (DLL) 195.

The read data transfer unit 190 outputs the data received from the data latch unit 180 to an external circuit. The read data latch 191 latches the data received from the data latch unit 180 and transfers the latched data to the multiplexer 192 in parallel. The multiplexer 192 selectively transfers the parallel data received from the read data latch 191 to the read driver 194. The data strobe signal generator 193 generates a data strobe signal DQS and provides it to the read driver 194. When the data is outputted to the external circuit, a level of the data strobe signal DQS is changed in synchronization with the data output. The number of data outputted from the semiconductor memory device can be calculated from numbers of the level change of the data strobe signal DQS. The read driver 194 outputs the data strobe signal DQS and the data in response to a clock signal outputted from the DLL 195. In order that the data is outputted in synchronization with a system clock CK, the DLL 195 compensates for a delay time until the system clock CK is transferred to the read driver 194 from the input of the system clock CK into the semiconductor memory device.

The write data input unit 200 includes a write data input circuit 201, an input register 202, and a write data transfer circuit 203. The write data input circuit 201 buffers external data and transfers the buffered data to the input register 202. The input register 202 aligns the buffered data into parallel data and transfers the aligned parallel data to the write data transfer circuit 203. The write data transfer circuit 203 transfers the aligned parallel data to the data latch unit 180.

As described above, the semiconductor memory device includes a plurality of internal blocks configured to output data in response to the read command and store data in response to the write command. In testing the write operation of the semiconductor memory device after its fabrication, the write command, the write address, and the write data are inputted to the semiconductor memory device from an external circuit through the test apparatus. Thus, many probes are used even when one semiconductor memory device is tested. The probes are connection terminals for transferring test signals to the semiconductor memory device.

To solve this problem, in testing the write operation of the semiconductor memory device, the semiconductor memory device in accordance with the embodiments of the present invention provides the write address and the write data from the internal circuits of the semiconductor memory device.

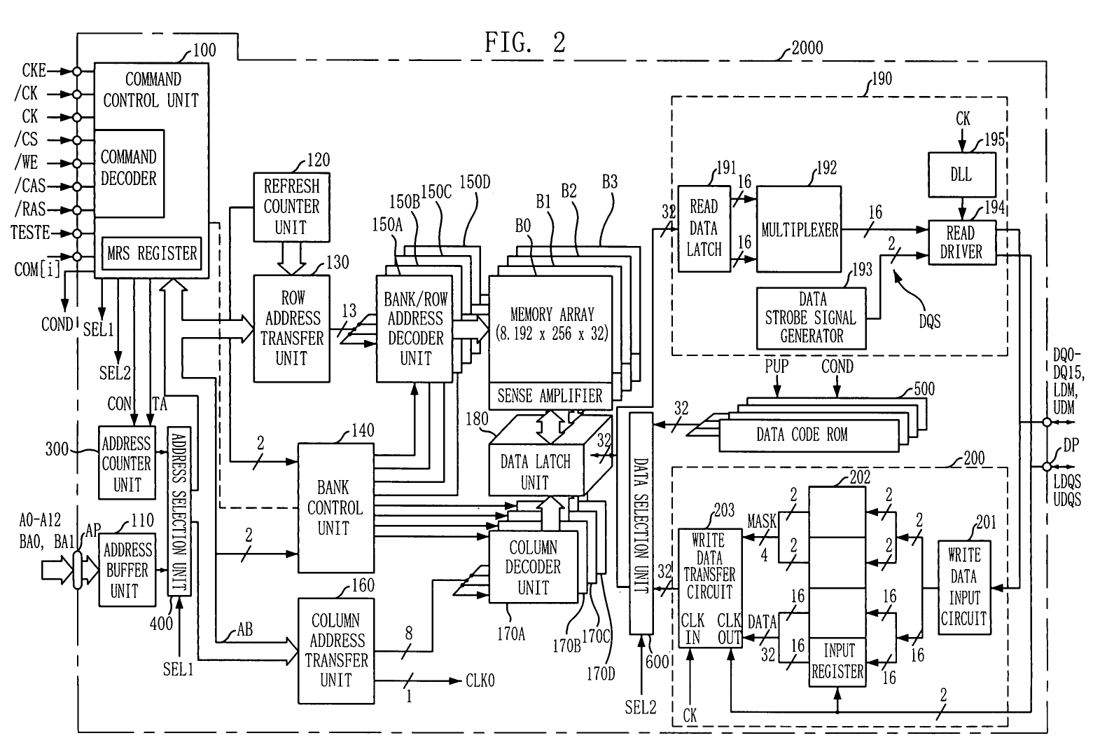

FIG. 2 is a block diagram of a semiconductor memory device in accordance with an embodiment of the present invention. In FIGS. 1 and 2, like reference numerals are used to refer to the same elements.

As shown, the semiconductor memory device 2000 includes a command control unit 100, an address buffer unit 110, a refresh counter unit 120, a row address transfer unit 130, a bank control unit 140, first to fourth bank/row address decoder units 150A to 150D, first to fourth memory arrays B0 to B3, a column address transfer unit 160, first to fourth column decoder units 170A to 170D, a data latch unit 180, a read data transfer unit 190, and a write data input unit 200.

In addition, the semiconductor memory device further includes an address counter unit 300, an address selection unit 400, a data code ROM 500, and a data selection unit 600. The address counter unit 300 generates a test address. The address selection unit 400 selects one of the test address and an address received from the address buffer unit 110 and transfers the selected address to the command control unit 100, the row address transfer unit 130, the bank control unit 140, and the column address transfer unit 160. That is, in a test mode, the test address is not inputted from an external circuit but is generated by the address counter unit 300. In a normal data access operation, the address selection unit 400 selects the address received from the address buffer unit 110.

The data code ROM 500 stores a test data. Specifically, the data code ROM 500 stores data patterns for testing the semiconductor memory device. The data selection unit 600 selects the test data received from the data code ROM 500 or data received from the write data input unit 200 and transfers the selected data to the data latch unit 180. In the test mode, the data selection unit 600 selects the test data stored in the data code ROM 500 and transfers the selected test data to the data latch unit 180. That is, the test data stored in the data code ROM 500 is inputted to a core region of the semiconductor memory device without receiving a test data from the external circuit. In a normal mode, the data selection unit 600 transfers the data received from the write data input unit 200 to the data latch unit 180.

The data code ROM 500 may store test data for a write command (hereinafter, referred to as “write test data”) or test data for a read command (hereinafter, referred to as “read test data”). When the data code ROM 500 stores the write test data, the write test data are transferred to the data latch unit 180 in response to the write command. When the data code ROM 500 stores the read test data, the read test data are stored in the memory arrays B0 to B3 through the data latch unit 180 before execution of the read command. Thereafter, the read test data stored in the memory arrays B0 to B3 are outputted through the read data transfer unit 190.

The address selection unit 400 is controlled by an address control signal SEL1 from the command control unit 100. The data selection unit 600 is controlled by a data control signal SEL2 from the command control unit 100. A test address signal TA outputted from the command control unit 100 is used for setting an initial value of the test address generated by the address counter unit 300. The address counter unit 300 is controlled by a first control signal CON. The data code ROM 500 is controlled by a second control signal COND. The command control unit 100 has separate input terminals for receiving a test enable signal TESTE and a test control signal COM[i] from the external circuit, i being a positive integer. The test enable signal TESTE is a signal for enabling the test mode, and the test control signal COM[i] is a signal for transferring information about a test pattern to be used among a plurality of predetermined test patterns stored in the data code ROM 500, information about generation of the address control signal SEL1 and the data control signal SEL2, and information about setup of the initial value of the test address generated by the address counter unit 300.

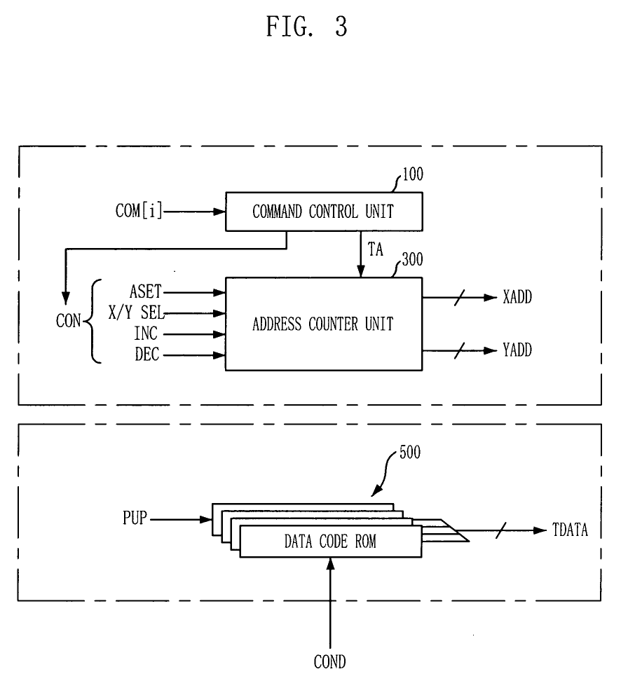

FIG. 3 is a detailed block diagram of the address counter unit 300 and the data code ROM 500 illustrated in FIG. 2.

Referring to FIG. 3, the address counter unit 300 generates the test address including a row address XADD and a column address YADD in response to the first control signal CON and the test address signal TA received from the command control unit 100. The first control signal CON includes an address setting signal ASET for setting an initial address, a select signal X/Y SEL for selecting one of the row address and the column address, an increment signal INC for incrementing the selected address, and a decrement signal DEC for decrementing the selected address.

The data code ROM 500 stores various test patterns in parallel. The data code ROM 500 is enabled in response to an enable signal PUP and outputs data TDATA corresponding to the selected data pattern in response to the second control signal COND.

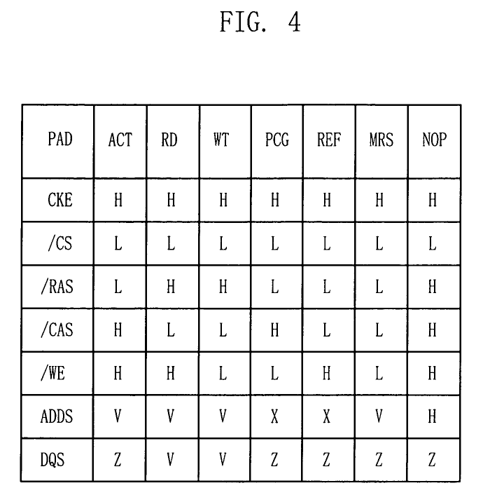

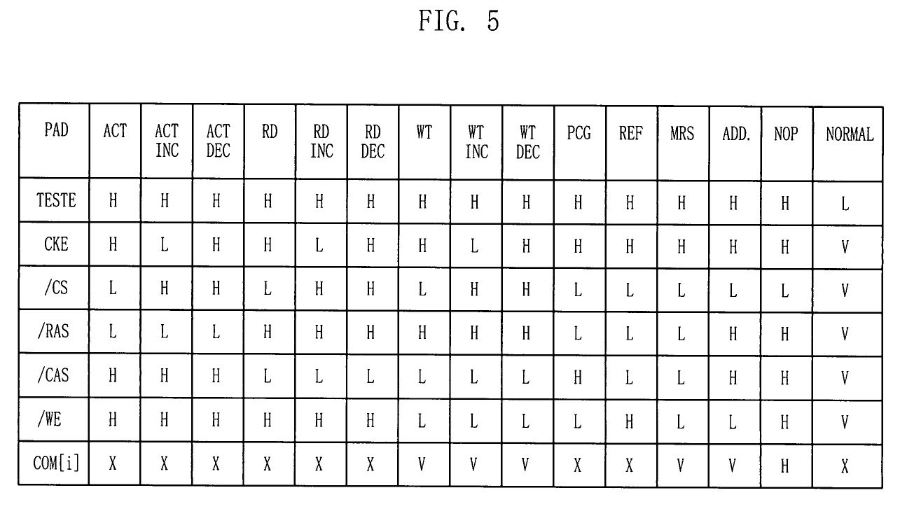

FIG. 4 is a table illustrating operation modes of the semiconductor memory device illustrated in FIG. 1, and FIG. 5 is a table illustrating operation modes of the semiconductor memory device illustrated in FIG. 2.

Referring to FIG. 4, an operation among, e.g., an active operation ACR, a read operation RD, a write operation WT, a precharge operation PCG, a refresh operation REF, and an MRS setting operation, is chosen according to a logic combination of a plurality of command signals /CS, /RAS, /CAS and /WE, while a clock enable signal CKE is activated. Then, the semiconductor memory device performs the chosen operation.

Referring to FIG. 5, the semiconductor memory device in accordance with the embodiment of the present invention receives the test enable signal TESTE and the test control signal COM [i] as well as the command signals /CS, /RAS, /CAS and /WE. When the test enable signal TESTE is a logic low level, the semiconductor memory device performs operations specified in the table of FIG. 4. When the test enable signal TESTE is a logic high level, the semiconductor memory device enters a special test operation mode. Various test operations can be performed according to a logic combination of the command signals /CS, /RAS, /CAS and /WE and a clock enable signal CKE when the test enable signal TESTE is a logic high level.

For example, the semiconductor memory device performs the active operation ACT for its test when the test enable signal TESTE is a logic high level, the clock enable signal CKE is at a logic high level, the command signals /CS and /RAS are a logic low level, and the command signals /CAS and /WE are a logic high level. In addition, when the test enable signal TESTE is a logic high level, the semiconductor memory device can perform an operation ACT INC of internally incrementing a row address or an operation ACT DEC of internally decrementing a row address. A read operation mode and a write operation mode respectively provide three operations. The first operation is to enter the corresponding operation mode, the second operation is to internally increment a column address, and the third operation is to internally decrement a column address.

As described above, in the test mode, the semiconductor memory device in accordance with the embodiment of the present invention provides the test address signal and the test data signal using its internal circuits, without receiving them from the outside. Thus, the number of external signals to be inputted to the semiconductor memory device is reduced, so that the test apparatus does not require a large number of probes for input of test signals. In addition, the test address signal and test data signal are not received from the external circuit, so that verification procedures are not required for determining whether the signals are correctly inputted, thereby saving the test time and improving the reliability of test results.

In accordance with the present invention, the number of the external signals inputted in the test mode can be reduced, and the number of the test signals provided from the test apparatus to the semiconductor memory device can be greatly reduced. Hence, the number of the probes of the test apparatus can be reduced and the test apparatus can test a large number of semiconductor memory devices at a time.

A semiconductor memory device in accordance with the present invention internally generates the test write data and the test write address, thereby performing a more accurate test and improving the reliability of the semiconductor memory device.

In addition, the semiconductor memory device generates the test address from its internal circuit, thereby significantly reducing the test time.

While the present invention has been described with respect to the specific embodiments, it will be apparent to those skilled in the art that various changes and modifications may be made without departing from the spirit and scope of the invention as defined in the following claims.

What is claimed is:

1. A semiconductor memory device, comprising:
a memory core region;
a data transfer unit configured to transfer external data to the memory core region;
a data code storage unit configured to store test data; and
a data selection unit configured to select one of the test data from the data code storage unit and the data from the data transfer unit and output the selected data to the memory core region.

2. The semiconductor memory device as recited in claim 1, wherein the data code storage unit comprises a read only memory (ROM).

3. The semiconductor memory device as recited in claim 1, further comprising an address counter unit configured to generate a test address corresponding to the test data stored in the data code storage unit.

4. The semiconductor memory device as recited in claim 1, further comprising a command control unit configured to receive a test enable signal and a test control signal from an external circuit and generate a control signal for controlling the data code storage unit.

5. The semiconductor memory device as recited in claim 1, wherein the data code storage unit stores the test data corresponding to a write command.

6. A semiconductor memory device, comprising:
a memory core region;
an address transfer unit configured to transfer an external address to the memory core region;
a test address generation unit configured to generate a test address; and
an address selection unit configured to select one of the test address from the test address generation unit and the address from the address transfer unit and output the selected address to the memory core region.

7. The semiconductor memory device as recited in claim 6, further comprising a data code storage unit configured to store data corresponding to the test address generated by the test address generation unit.

8. The semiconductor memory device as recited in claim 7, wherein the data code storage unit comprises a read only memory (ROM).

9. The semiconductor memory device as recited in claim 6, further comprising a command control unit configured to receive a test enable signal and a test control signal from an external circuit and generate a control signal for controlling the test address generation unit.

10. The semiconductor memory device as recited in claim 6, wherein the test address generation unit generates the test address corresponding to a write command.

11. A semiconductor memory device, comprising:
a memory core region;
a data transfer unit configured to transfer external data to the memory core region;
a data code storage unit configured to store test data;
a data selection unit configured to select one of the test data from the data code storage unit and the data from the data transfer unit and output the selected data to the memory core region;
an address transfer unit configured to transfer an external address to the memory core region;
a test address generation unit configured to generate a test address; and
an address selection unit configured to select one of the test address from the test address generation unit and the address from the address transfer unit and output the selected address to the memory core region.

12. The semiconductor memory device as recited in claim 11, further comprising a command control unit configured to receive a test enable control signal and a test control signal from an external circuit and generate a first control signal for controlling the data code storage unit and a second control signal for controlling the test address generation unit.

13. The semiconductor memory device as recited in claim 12, wherein the command control unit generates a first selection signal for controlling the data selection unit, and a second selection signal for controlling the address selection unit.

14. The semiconductor memory device as recited in claim 11, wherein the data code storage unit stores the test data corresponding to a write command.

15. The semiconductor memory device as recited in claim 11, wherein the test address generation unit generates the test address corresponding to a write command.

16. The semiconductor memory device as recited in claim 14, wherein the data code storage unit comprises a real only memory (ROM).

17. A semiconductor memory device, comprising:
a data transfer unit configured to transfer external data to a memory core region;
a data pattern read only memory (ROM) configured to store test data;
a data selection unit configured to select one of the test data from the data pattern ROM and the data from the data transfer unit and output the selected data to the memory core region;
a command decoder configured to receive a test enable signal and a test control signal from an external circuit and generate a control signal for controlling the data pattern ROM; and
an address counter configured to generate a test address corresponding to the test data stored in the data pattern ROM.

18. The semiconductor memory device as recited in claim 17, wherein the data pattern ROM stores the test data corresponding to a write command.
